(19) United States
(12) Patent Application Publication
(10) Pub. No.: US 2003/0183728 A1
(43) Pub. Date: Oct. 2, 2003

(54) Aircraft control surface controller and associated method

(75) Inventor: Neal V. Huynh, Bellevue, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/112,815

(22) Filed: Mar. 29, 2002

(51) Int. Cl. B64C 13/14

(52) U.S. Cl. 244/224

(57) ABSTRACT

A control surface controller and a method of controlling a control surface interface includes a control surface interface for controlling one or more of the aerodynamic control surfaces on an aircraft, such as ailerons, spoilers, elevators, and a rudder. A control surface controller and a method of controlling a control surface interface also include a variable resistance damper that provides physical resistance to the control surface interface in proportion to control surface interface input rate. Accordingly, the resistance provided to the control surface interface may be selected in order to prevent the cause of pilot-induced-oscillation or airplane-pilot coupling. The resistance provided to the control surface interface may also be selected in order to limit the servovalve rate which reduces peak transient hydraulic fluid pressure in the hydraulic system.

### FIELD OF THE INVENTION

The present invention relates to aircraft control surface controllers, and, more particularly, to an active flight control suppressing method and variable resistance damper that reduces a pilot's authority over the control system as the frequency of the pilot control input increases. The variable resistance damper of the present invention can be installed in a flight control system between other flight body parts.

### BACKGROUND OF THE INVENTION

In an aircraft, the amplitude of the aerodynamic forces due to the speed and span of the aircraft makes it impossible to operate the control surfaces directly. In fact, the necessary forces are produced by hydraulic servo actuators whose irreversibility prevents the transmission of aerodynamic reactions back to a pilots' controls. These hydraulic servo actuators all have rate limits due to limits in hydraulic supply, etc. In order to provide the pilot with the reaction forces required for correct flying of the aircraft with hydraulic servo actuators, an artificially induced “feel” system is located in the control linkages. This “feel” is extremely important in that it provides a tactile feedback to the pilot. In aircraft control systems, the rotary or linear jam override device is used in connection with the hydraulic servo actuators or system linkages. The rotary or linear jam override device permits the pilot to override a jammed hydraulic servo actuator or system linkages. As one hydraulic servo actuator or system linkage jams, the jam override device slips at a preset pilot input force and enables the pilot to operate the remaining actuators or system linkages.

A common problem of the above systems includes pilot-induced-oscillation (PIO) or pilot-airplane-coupling (APC). Generally, pilot-induced-oscillation occurs as a result of unusually high pilot control input rates provided to the control surface hydraulic servo actuators. This occasionally occurs when the pilot is engaged in demanding tasks while diligently maneuvering the aircraft at an unusually high input rates. Consequently, the response of the control surface actuators become rate limited. The actuator rate limiting results in a slippage condition of the jam override device. In the slippage condition, the spring force of the jam override device and the reaction force from artificial feel system are out of phase which results in a drop off of reaction force for the pilot. This causes the pilot to make an overcorrection that results in a large reverse correction, and subsequently oscillation if the process is repeated. The higher rate of pilot control input therefore aggravates the pilot-induced-oscillation.

Pilot-induced-oscillation (PIO) or pilot-airplane-coupling (APC) has long been recognized as a significant effect regarding aircraft control instability. Many in the field have studied the effects of pilot-induced-oscillation and developed general criteria and aircraft specific criteria for estimating expected flight results. From these criteria, systems have been developed to suppress pilot-induced-oscillation due high control input rates. However, these models have yet to provide a solution to actually limiting the phenomena at the source, the pilot and the control surface interface.

One damping system developed for the Boeing 777, manufactured by The Boeing Company of Seattle, Wash., comprised a rotary hydraulic damper to provide damping in the fly-by-wire control systems. Another damping system developed for the Boeing 757-300 also comprised a rotary hydraulic damper to reduce the effect of pilot induced oscillation on the elevator mechanical control systems. The hydraulic damper consists of a shaft with one or more integral vanes and a cylindrical housing with two or more compartments. A typical rotary hydraulic damper has two shaft vanes and four chambers. Opposite chambers are connected and the two pairs are connected by porting fluid through a throttle valve. Relative rotation between the shaft and housing displaces fluid from one pair of chambers through the throttling valve into the other pair of chambers. The porting of the throttling valve and the relative rotation produces the resistance (so called linear damping force) relative to the input rotation and impedes the undesired high rate input.

The hydraulic damper worked well for its intended purpose on the 777 fly-by-wire control systems and 757-300 elevator control system, however, the linear damping force as well as the damping rate, response time, and control proscribe its use with other flight control systems. Neither of these systems provided damping relative to the input rate of the control surface interface. More particularly, many lateral mechanical control systems must have both a low control break out force (control break out force is defined as the pilot input force to initiate the first control surface movement) and an unchanged reaction force during normal aircraft operation. The prior hydraulic damper systems increased both the control break out force and the reaction forces in normal aircraft operation. The prior hydraulic dampers were suitable for fly-by-wire control systems because those control systems do not use control cable, pulleys, quadrants and control linkages between the pilot controller and the hydraulic servo actuators. Also, another primary problem associated with hydraulic dampers has been the mechanical seals, which retain the viscous fluid in the damping chamber. These seals are subject to wear and eventually leak resulting in a loss of the damping fluid. Loss of the fluid degenerates the damping effectiveness of the hydraulic damper.

### BRIEF SUMMARY OF THE INVENTION

Therefore, the present invention provides a control surface controller and method of controlling a control surface interface in order to effectively limit the rate of input to the control surface interface thus preventing pilot-induced-oscillation. The control surface interface provides pilot input for positioning aerodynamic control surfaces on an aircraft. Generally an aircraft includes many aerodynamic control surfaces including ailerons, spoilers, flaps, elevators, and rudders. Any one or more of these control surfaces are responsive to the control surface interface. Also interconnected to the control surface interface is a variable resistance damper. The variable resistance damper provides rate dead zone and physical resistance to the control surface interface proportional to its rate of movement. The rate dead zone may advantageously be selected in order to provide proportional physical resistance to the control surface interface during high input rates, which tend to lead to pilot-induced-oscillation.

According to one embodiment, a variable resistance damper with a rate dead zone is provided. In the rate dead zone, the variable resistance damper generates no damping force so the control break out force and reaction forces in normal aircraft operation are not affected. The variable resistance damper is basically transparent to the pilot in normal aircraft operation. Beyond the rate dead zone, the variable resistance damper generates the damping force as well as the response time between damping engaged and damping disengaged is much faster than the presently used hydraulic damper. Thus, the enhanced lateral mechanical control system requirements have created an invention for which an active suppressing method using a variable damper reduces the pilot's authority over the control system as the frequency of the pilot control input increases.

Another aspect of a control surface controller and method of controlling a control surface interface includes a rotary or linear jam override device interconnecting one of two or more control surface controllers and the control surface interface which allows a jammed actuator or linkage to be removed from the system in order to operate the unjammed actuators or linkages. Typically, the rotary jam override device comprises a roller and a heart shaped cam of which the roller is normally positioned at the cam detent and is preloaded by the spring force. Pogo or spring rod is one form of the linear jam override device.

In many applications of the control surface controller and method of controlling a control surface interface it is desirable that the variable resistance damper is included. Various types of variable resistance dampers may be used. One advantageous embodiment employs an electric motor. More specifically, one embodiment includes a direct current brushless motor-generator combination. Another embodiment employs magnetic field restraint on a rotor, such as in an eddy current drag device. In other applications of a control surface controller and method of controlling a control surface interface it is desirable that the variable resistance damper comprises a mechanical brake. One embodiment of the mechanical brake comprises a centrifugal friction braking mechanism.

Each of these embodiments are particularly well suited to providing the desirable torque and rate proportionality in an efficient and self-contained manner. That is to say that each embodiment may be self powered and therefore independent of external power sources, thus advantageously improving reliability. However, other embodiments may comprise external power and external controls in order to provide variable resistance damping, as well.

Additionally, it is often desirable to control shaft torque of the variable resistance damper at a higher rate, while at the lower rate there is no damping torque. Therefore, one embodiment of a control surface controller and method of controlling a control surface interface further comprises a mechanical gear train interconnecting the control surface interface and the variable resistance damper. The mechanical gear train provides a speed increasing from the damper input shaft to the damper.

Generally, the mechanical control surface controller and method of controlling a control surface interface may include mechanical linkages, such as a cable, pulley, and quadrant system interconnecting the control surface interface and an actuator for actuating a control surface. Alternatively, the fly-by-wire control surface controller and method of controlling a control surface interface may also include electromechanical devices, such as electromechanical trim actuators and fly-by-wire control transducers, interconnecting the control surface interface and an electro-hydraulic servo actuator for actuating a control surface.

Another aspect of the present invention also provides a method of controlling the rate of a pilot control surface interface in order to effectively limit the rate of pilot input to the control surface interface thus preventing the pilot-induced-oscillation condition. In this regard, the method comprises receiving an input rate from the control surface interface and in return applying a physical resistance to the control surface interface. The physical resistance is proportional to the pilot input rate.

In one advantageous embodiment, the physical resistance to the control interface begins once the control surface interface has moved beyond one or more of an initial damping criteria. One initial damping criterion corresponds to a predetermined rate of the control surface interface. Another initial damping criterion may additionally correspond to a predetermined position of the control surface interface from a nominal position of the control surface interface. The initial damping criteria are selected based upon the physical control system response properties and aerodynamic effect properties of the control surfaces in response to the control surface interface, generally in relation to pilot-induced-oscillation condition.

Therefore, the present invention builds on the technique of active damping to provide a system and method that suppress a pilot-induced-oscillation condition on large transport aircraft that is caused by control system rate limiting. To effectively limit the high rate input during flight, the present invention employs a system comprising a self-contained variable resistance damper that can be installed in a flight control system by insertion between other flight body parts. The method of active damping of the present invention is intended to be completed before the occurrence of flight control system rate limiting condition thereby preventing pilot-induced-oscillation condition.

In accordance with another aspect of the invention, it is also advantageous to control the input rate of the damper beyond a threshold of initial damping criteria. That is to say that damping does not begin until the control surface input exceeds the initial damping criteria. One initial damping criterion corresponds to a predetermined rate of the control surface interface. Generally, at input rates below the predetermined rate pilot-induced-oscillation is not a significant problem, and therefore damping may not be required. Another initial damping criteria is a predetermined position of the control surface interface from a nominal position. This aspect is relevant for applications where small movements are not significant factors contributing to pilot induced oscillation.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic of a prior art aircraft control surface control controller system;

FIG. 2 is a plan view of an aircraft having control surfaces operated by a control surface controller;

FIG. 3 is a schematic of a control surface controller according to one embodiment of the represent invention;

FIG. 4 is a graph illustrating a shaft torque and shaft rate characteristic for a damper according to one embodiment of the present invention;

FIG. 5 is a frontal view of a damper having a rotor according to one embodiment of the present invention;

FIG. 6 is a block diagram of a variable resistance damper and a gear train according to one embodiment of the present invention;

FIG. 7 is a block diagram of an eddy current drag device damper according to one embodiment of the present invention;

FIG. 8 is a schematic diagram illustrating the operation of a motor-generator damper according to one embodiment of the present invention; and

FIG. 9 is a block diagram illustrating the operation of a centrifugal brake damper according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

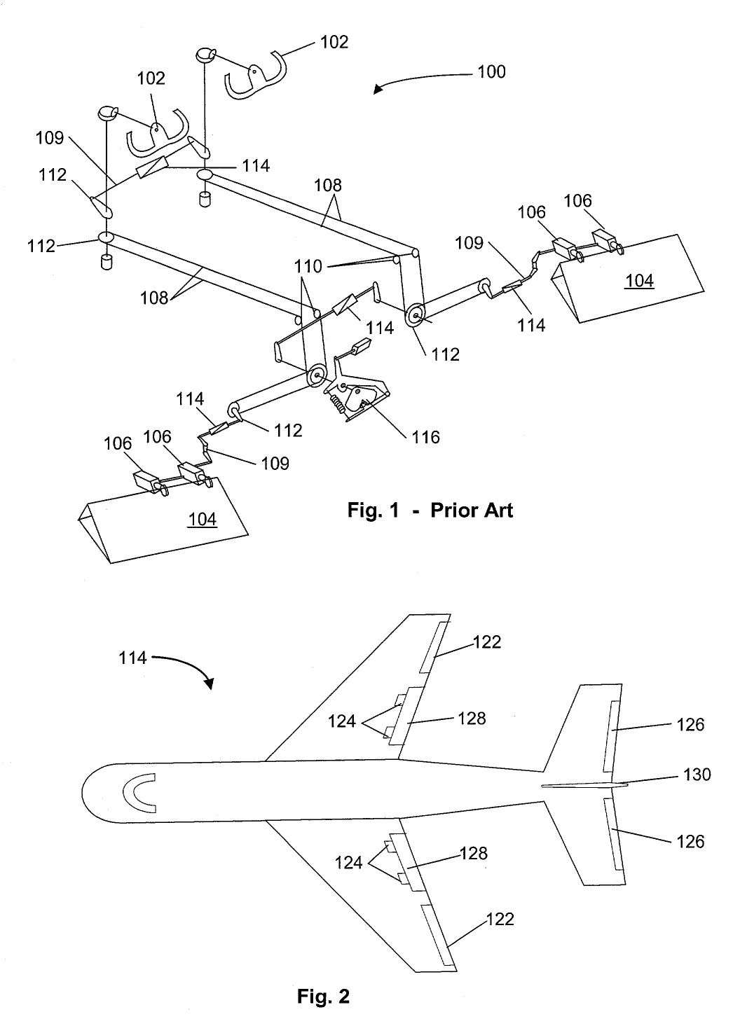

Referring now to FIG. 1, a typical aircraft control surface control system 100 is illustrated. The system generally includes a control surface interface 102 or a pair of control surface interfaces 102, such as control wheels, control sticks, yokes, or pedals. The control surface interface 102 is connected to the aerodynamic control surface 104 and the control surface actuators 106 via mechanical linkages, such as cables 108, pulleys 110, cable quadrant 112, and linkages 109 for translating the motion of the control surface interface 102 to the actuators 106. The actuators 106 maneuver the aerodynamic control surfaces 104 to a position corresponding to the input of the interface 102 as desired by the pilot. Often the actuators 106 include hydraulic actuators or the like. As illustrated, one control surface interface 102 may control more than one aerodynamic control surface 104, for example a control wheel typically controls ailerons on the port and starboard wings. Additionally, a feel system 116, typically providing linear resistance based strictly on position, is also provided.

Additionally, a typical aircraft control surface control system 100 also includes one or more jam override devices 114 within the mechanical linkages, especially when one control surface interface 102 controls more than one aerodynamic control surface 104 or when redundant systems are incorporated. When an actuator 106 fails to a jammed condition, a jam override device 114 permits operation of unjammed actuators by removing the jammed actuator from the system. The jam override device 114 is typically a rotary that comprises a roller and a heart shape cam of which the roller is positioned at the cam detent and is preloaded by the spring force, depending on the type of jam override device. Alternatively, the jam override device may also be a linear type such as a pogo or a spring rod. As the control surface interface is turned against the resistance of a jammed actuator or linkage, the resulting force exceeds the detent force. The detent force is defined as the force threshold that causes the override device to slip. The detent force causes a relative motion of the two halves of the jam override device and thus isolates the jammed actuator or linkage from the system. It will also be noted that the illustration demonstrates redundant systems of control surface interfaces 102, cables 108, pulleys 110, cable quadrants 112, and linkages 109. In this case, the jam override device 114 provides a similar function between redundant systems, when one system jams the jam override device 114 slips and removes the jammed portion of the system.

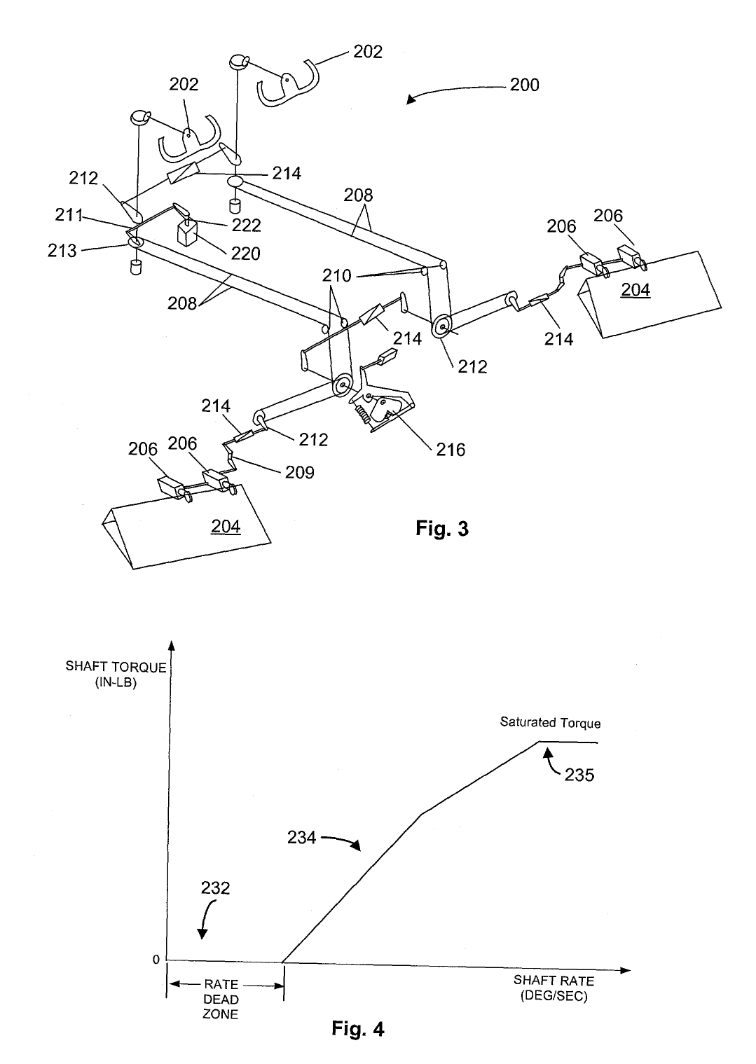

Referring concurrently to FIG. 2, the aerodynamic control surfaces of a typical aircraft 120 include ailerons 122, spoilers 124, elevators 126, flaps 128, and rudders 130. The control surface controller and method of controlling a control surface interface as described herein may be used in conjunction with any of these surfaces or any other control surface that provides aerodynamic properties to permit flight maneuvering. FIGS. 1 and 3 specifically illustrate control surface interfaces 112, 212 that are control wheels for operating control surfaces 104, 204, however, this is by way of example only and not intended to limit the application of the invention to other control surface interfaces. Examples of such control surface interfaces include yokes, pedals, levers, and other similarly designated pilot aircraft interface devices.

Referring now to FIG. 3 and in accordance with one embodiment of the present invention, a control surface controller 200 and method of controlling a control surface are provided. The control surface controller 200 includes a control surface interface 212, as previously described, and further comprises a variable resistance damper 220. The variable resistance damper 220 is interconnected to the control surface interface 202 via a four-bar linkage 211 and damper rotor 222. The variable resistance damper 220 provides a variable physical resistance force to the control surface interface 202.

In particular, the variable resistance damper 220 provides additional resistance to the control surface interface 202 proportional to the rate of movement of the control surface interface 202. By way of example, the mechanical linkages from the control surface interface 202 operate a rotor 222 on the variable resistance damper 220. The rotor shaft rate corresponds to the control surface interface 202 input rate. The torque on the rotor 222 is, in response, varied in proportion to the rate in order to provide resistance to the control surface interface 202. Therefore, by selectively controlling the torque on the rotor 222 proportionally to rotor shaft rate, and thus control surface interface input rate, the variable resistance damper 220 provides additional physical resistance to the interface 202. When the rate dead zone limit 232 is selected with respect to the rate limits of the actuators and other factors relating to pilot-induced-oscillation, the control surface controller 200 may then prevent the cause of pilot-induced-oscillation at the source, namely the control surface interface 202.

As such, the variable resistance damper 220 is incorporated into the control surface controller 200 such that feedback, the additional physical resistance, from the variable resistance damper 220 is provided directly to the control surface interface 202 in response to the control surface interface input rate. The control surface interface 202 is further interconnected to the control surface actuators 206 and aerodynamic control surfaces 204 via cables 208, pulleys 210, cable quadrants 212, bar linkages 209, and a feel system 216. The control surface actuator 206, therefore, positions the aerodynamic control surface 204 in a manner corresponding to the position of the control surface interface 202, regardless of the variable resistance damper. Accordingly, this particular example of variable resistance damper 220 control for this embodiment of the control surface controller 200 and a method of controlling a control surface interface may be described as an open loop control system.

While this embodiment of a variable resistance damper provides open loop feedback, the selection of the magnitude and proportionality of the resistance in relation to the rate of input is nonetheless dependent upon the limiting rates of the control surface actuators 206 and the aerodynamic response of the aircraft in response to the corresponding movement of the aerodynamic control surfaces 204. Designers of aircraft generally have mathematical models for determining how actuator rate limitations and other system parameters contribute to pilot-induced-oscillation. In applying these models to each specific system and aircraft, appropriate rate limits for each control surface and control surface interface may be selected. Consequently, pilot-induced-oscillation may be limited at its source, the control surface interface 202. Also, the rate limit described herein is referred to as proportionally controlled, and proportionally controlled may include any number of desirable outcomes related to these models such that the torque of the damper 220 increases in relation to the rate of the control surface interface input.

It will also be noted that constraining the control surface interface 202 to within the maximum rate of the actuator 206 will also prevent undesirable slippage of the associated jam override devices 214. In the prior art, such as in FIG. 1, the control surface interface input rate could increase beyond the actuator rate so the actuator input lever contacts a mechanical stop. The stop contact condition and the control surface interface input force exceeds the detent force of the jam override device 114 will cause the override to slip and temporarily remove the actuator from operation, even though the actuator 106 was not actually jammed. However, referring again to FIG. 3, when the control surface controller 200 and method of controlling a control surface interface of the present invention establishes physical resistance to the control surface interface 202 within the rate limits of the actuators 206, so the mechanical stop contact events of the actuator input lever will mostly be eliminated and the jam override will not be caused to artificially slip. Furthermore, the control surface controller 200 and method of controlling a control surface interface of the present invention do not affect the normal operation of the jam override 214.

While the control surface controller 200 and method of controlling a control surface interface have been described in conjunction with conventional cables, pulleys, and mechanical linkage systems for controlling control surface actuators and control surfaces, the foregoing principles may likewise be applied to electromechanical fly-by-wire control systems also used for the same purpose. For example, electrohydraulic servo actuators are used in conjunction with manual input systems, and one example includes fly-by-wire control systems. While fly-by-wire control systems may develop algorithms and software control schemes for limiting the effect of pilot-induced-oscillation, the control surface controller and method of controlling a control surface interface of the present invention may also be incorporated in order to provide a more effective response to the pilot through the control surface interface. Therefore, the control surface controller and method of controlling a control surface interface provide an aid to the pilot to consciously prevent pilot-induced-oscillation at the source, rather than singular reliance upon flyby-wire control systems to limit the effect at the output.

Other applications of the control surface controller and method of controlling a control surface interface of the present invention may also be incorporated in order to limit or control the maximum servovalve rates. Electro-hydraulic servovalves are used in aircraft fly-by-wire flight control systems and each of which is under the control of an electrical command signal. The electrical command signal is produced as a result of the control surface controller or the autopilot control surface interface. Under transient conditions, the above system causes a hydraulic peak pressure that exceeds the maximum acceptable limit and results in a reduced fatigue life of the hydraulic tubing and other components. A typical approach utilizes an accumulator to limit the transient peak hydraulic pressure. Another approach increases the diameter size of the hydraulic tubing. Both add significant cost and weight, and the former adds maintenance requirements to the aircraft. The present invention, therefore, may be tailored to reduce the system gain that slows down the servovalve rate without degradation of normal actuator dynamic performance.

Likewise, the foregoing examples illustrate an open loop method for controlling a control surface interface, however, the same principles may be applied in conjunction with a closed loop system. For example, a closed loop control may additionally receive additional input data from fly-by-wire computer, from the control surface actuator, the aerodynamic control surface, an associated sensor, or any other mechanism or sensor that is related to controlling an aerodynamic control surface. As such, the feedback torque of the variable resistance damper may be modulated in proportion to the input rate plus any one or more of these other possible feedback mechanisms.

In one embodiment, it is advantageous to provide the proportional resistance only when the control surface interface 202 exceeds a threshold rate. Referring now to FIG. 4 and with continued reference to FIG. 3, there is illustrated one such desirable torque response 234 of the variable resistance damper 220 with respect to the rotor 222 shaft rate of the variable resistance damper. The shaft rate, of course, corresponds directly to the control surface input rate. As such, at lower input rates, the damper does not provide any additional damping to the control surface interface. This undamped area 232 represents the normal operation of the control surface interface where pilot-induced-oscillation either does not occur or does not occur to any undesirable magnitude. Such an area is determined from the physical response characteristics of the aerodynamic control surface 204, the control surface actuator 206, and the aerodynamic response of the aircraft to the movement of the control surface. Typically, these are based on the previously discussed pilot-induced-oscillation models and will vary from aircraft to aircraft. Therefore, these parameters will be well known to the aircraft control system designer following a case-by-case basis. A maximum torque 235, or saturated torque, is typically prescribed at the maximum limits of the damper, and should be selected beyond the maximum expected torque applied to the control surface interface.

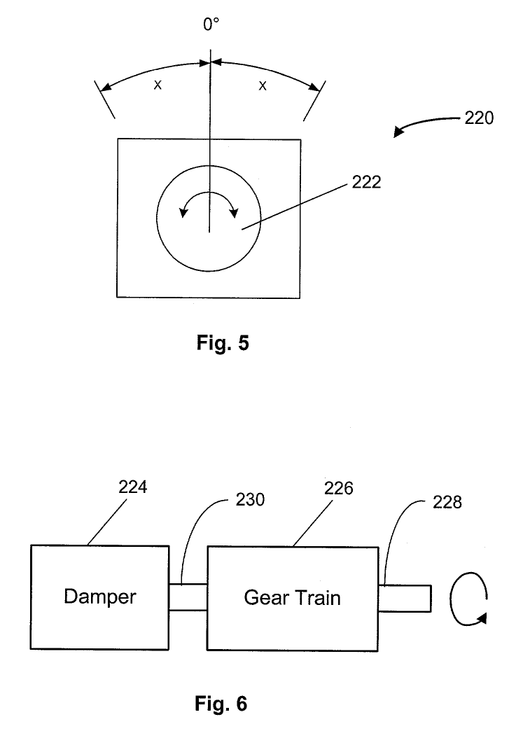

Referring now to FIG. 5 and with continued reference to FIG. 3, in another embodiment of the control surface controller 200 and a method of controlling a control surface interface it is desirable to provide a range of motion of the control surface interface 202 where the interface is undamped. For example, a nominal position of a control surface interface 202 corresponds to nominal positions of the control surfaces that it controls. A position of the rotor 222 on the damper corresponds to the nominal position and for ease of explanation is designated zero degrees. On either side of the nominal position, ±X degrees, an undamped zone may be selected, and at X degrees a threshold position of damping is reached. The undamped zone of motion generally corresponds to control surface responses and aerodynamic responses where pilot-induced-oscillation does not occur or does not occur to any undesirable magnitude. Therefore, beyond the threshold position of the control surface interface, damping begins and is also proportional to the rate of control surface input, as described above and illustrated in FIG. 4 for example.

Generally on a rotating machine, the required damper torque is more easily obtained or controlled at higher rotor shaft rates. Therefore, FIG. 6 illustrates one advantageous embodiment of a variable resistance damper 224 that includes a gear train 226 having a gear reduction of the damper rotor 230 to an external rotor 228. The external rotor 228 is mechanically linked to the control surface interface. Typically, these gears will comprise helical gears, spur gears, or planetary gear trains. As will be recognized by one of ordinary skill in the art, the specific gear type and gear ratio will be chosen according to the torque and physical resistance requirements of the control surface interface in comparison to the torque abilities of the damper 222 itself.

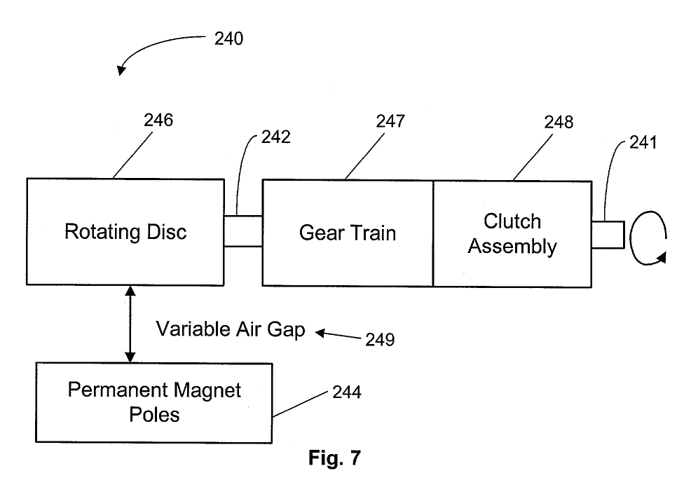

Referring now to FIG. 7, one embodiment of the variable resistance damper includes an eddy current damper 240, and, more specifically, a self-contained and self powered eddy current drag damper 240. In this particular embodiment, an eddy current damper 240 consists of permanent magnetic poles 244 which place restraint on an electrically conductive rotating disc 246 via a variable air gap 242.

The eddy current damper 240 is particularly well suited as a variable resistance damper due to the natural proportionality of the torque to revolution rate characteristic. In operation, the disc 246 rotates within the magnetic field of the magnetic poles 247 so that the direction of the magnetic flux passing through the disc 246 changes in the rotation direction. From Faraday's law, the time-varying magnetic fields result in eddy current that circulates in the rotating disc 246 whereby a magnetic force in the reverse direction to the rotation direction of the disc 246 is generated under Fleming's rule, thereby exerting a braking torque on the rotating disc 246. The braking torque, as mentioned above, is controllable by adjusting the air gap 249 and the rate of rotor 242. For a constant airgap 249, the braking torque is substantially proportional to rotor speed. Therefore, the eddy current damper 240 embodiment of the variable resistance damper provides an advantageous self contained and self powered apparatus that does not require external electrical power sources, therefore retaining reliability of the damper independent of electrical power supplies.

The eddy current damper rotor 242 is connected to a gear train 247, such as has been previously described. A slip type, self-re-engagement clutch assembly 248 is also provided upstream of the gear train 247 and acts as an overload protective device for the gear train and as a jam override device for the system. The external rotor 241 connected to the clutch then receives the input from the control surface interface 202 by way of the mechanical linkages 211, 213.

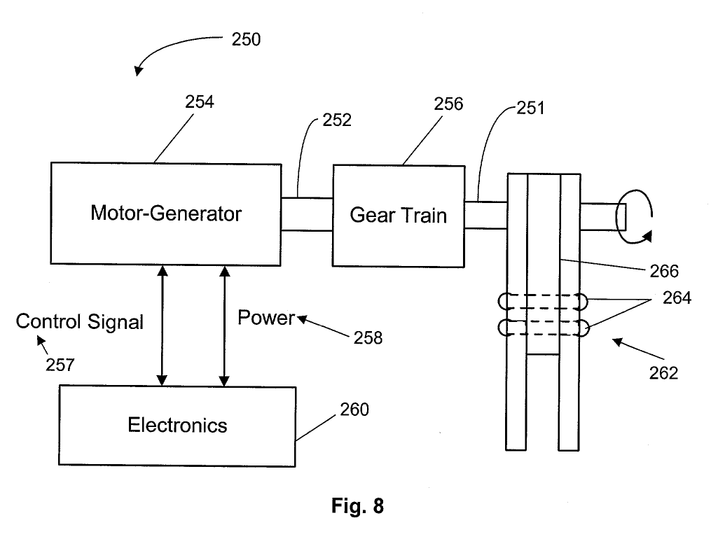

Referring now to FIG. 8, another embodiment of the variable resistance damper includes an electrical motor, and, in one specific advantageous embodiment a self contained, self powered, and electronically controlled motor-generator 250. The motor-generator portion 256 of the machine comprises a DC brushless motor. The rotor 252 contains an array of identical permanent magnets that provide a uniform dipole field. The windings of the motor 254 are on the stator. The stator windings are then “switched” or “commutated” to provide a DC motor-generator. The operation mode of a DC brushless motor is different from that of a typical DC motor in that the commutation of a brushless motor can be performed by electronic means using switching circuits rather than using brushes across a commutator from the rotor. Therefore, the undesired problems (i.e. brush wear, arcing, explosion, etc.) related to mechanical structure can be overcome by replacing the mechanical means with electronic means such as power semiconductor devices or ICs for signal processing so as to control the three-phase current of the DC brushless motor and achieve better operation characteristics.

The DC brushless motor is used as a generator to provide a control signal 257 and power supply 258 to the electronic control circuit 258. The power supply 258 thus permits a self-contained and self powered unit. As the motor-generator operates as a generator, the current output is measured from the control signal 257. As such, the measured value of the current is proportional to rotor rate, and thus proportional to control surface interface input rate. The electronic circuit 258 thus uses the control signal in a feedback manner to provide control of the stator commutation on the motor 256 to achieve the damping torque profile proportional to shaft rate, such as provided in FIG. 4 for example. This is generally achieved by electronic circuitry 258 incorporating one or more static power switches or solid state relays comprising power diodes, power transistors, thyristors, or the like.

There are several advantages of this particular embodiment. First, the local electronic circuit 258 control can be performed at a high frequency to achieve fast damping engagement and fast damping disengagement that results in high fidelity force feedback functionality. Secondly, the process of optimizing the damping rate does not have to execute manually, as does the hydraulic damper. Instead the magnitude of damping may be adjusted while flying the airplane. Thirdly, certain damper maintenance checks can be performed by measuring the motor-generator output current. The measured value allows a determination of the damping parameters. Fourthly, the electronic circuit 258 also limits or saturates the damper output torque 235 so that overload protection is provided.

In one particularly advantageous embodiment, the rotor 252 of the motor-generator is connected to the control surface interface by mechanical linkages 211, 213 and a gear train 256. In this particular embodiment, the mechanical linkages include a crank assembly 262. The crank assembly 262 attached to the damper input shaft has shearable rivets 264 that pass through a crank hub 266. The shearable rivets 264 are capable of accommodating the damper torques. However when movement of the damper input shaft is encumbered the control surface input force produces a high stress concentration on the shearable rivets 264 causing them to shear and thereby enables the pilot to operate the control system.

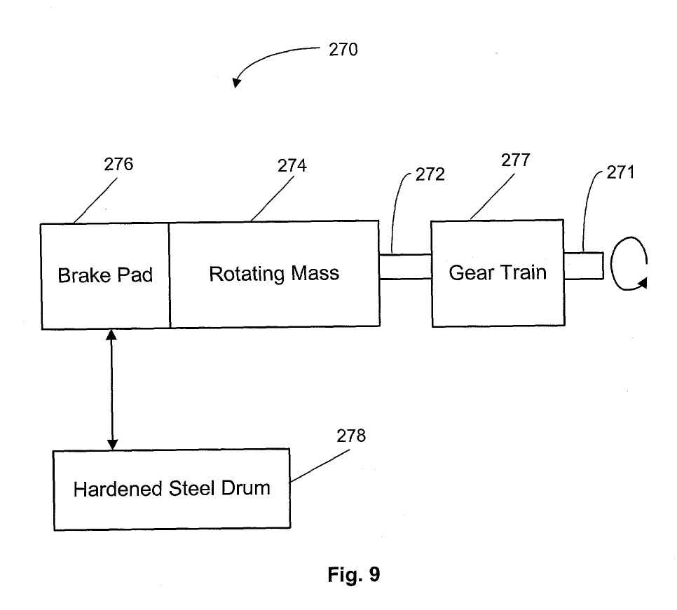

Referring now to FIG. 9, another alternative embodiment of the variable resistance damper comprises a mechanical brake, and more specifically a self contained centrifugal friction braking mechanism 270. In this particular advantageous embodiment, the centrifugal friction brake comprises a rotor 272 having centrifugally extending rotating mass 274 and brake pad 276. The rotor 272 is connected to the control surface interface by mechanical linkages and a gear train. The extension of the mass 274 is generally controlled by rotor rate and an elastic element (not shown) between the rotor and the mass. As a result, the brake pad 276 is pressed against a hardened steel drum providing braking torque to the rotor 272. Therefore, the initial damping threshold, as in FIG. 4 for example, may be controlled through the preload on the elastic element. When the preload force is exceeded, the mass 274 then extends toward the drum 278. Additionally, a torque versus rate characteristic, also as in FIG. 4 for example, may be controlled by adjusting the mechanical advantage between the brake pad 276 and the rotating mass 274, thus adjusting the braking torque. Additional masses may further be used to control the torque. A gear train, as described previously, also provides increased rotor speed. An external rotor 271 is then mechanically interconnected to the control surface interface 202. Therefore, the centrifugal braking mechanism 270 advantageously provides a self contained and self-powered variable resistance damper.

Although it is advantageous to provide a self contained and self powered variable resistance damper in most applications, the principles illustrated herein are not necessarily limited to self-contained and self powered dampers. With respect to an eddy current damper, stator windings powered by an external power supply may be substituted for the described permanent magnets. In particular, electrically powered eddy current drag devices are used in the arts of motor clutches and brakes and have electrically excited stators that are controlled by circuitry to precisely vary developed torque in the rotor. With respect to a motor variable resistance damper, the electronics and/or the motor excitation may be powered by external power supply. Similarly, the electronics controlling motor excitation may be controlled in order to vary the toque versus rate characteristics as may be required. With respect to the mechanical brake, many other types of externally controlled brakes such as disc brakes, rim brakes, and other drum brakes may be substituted accordingly. These examples, and others, of variable resistance dampers that are not self contained or not self-powered may be used without departing from the spirit and scope of the present invention.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An aircraft control surface controller for controlling aerodynamic control surfaces on an aircraft, comprising:
a control surface interface having a range of motion for providing pilot input for positioning the aerodynamic control surfaces on an aircraft; and
a variable resistance damper mechanically interconnected to the pilot control surface interface, wherein the damper provides physical resistance to the control surface interface, the damper physical resistance increases proportional to a rate of movement of the control surface interface.

2. The aircraft control surface controller according to claim 1, wherein the variable resistance damper provides physical resistance to the control surface interface once the control surface interface exceeds an initial damping criterion corresponding to a predetermined rate of the control surface interface.

3. The aircraft control surface controller according to claim 2, wherein the variable resistance damper provides physical resistance to the control surface interface according to a second initial damping criterion corresponding to a predetermined position of the control surface interface from a nominal position of the control surface interface.

4. The aircraft control surface controller according to claim 2, wherein the variable resistance damper initial damping criterion and physical resistance are selected based upon the physical response properties and aerodynamic effect properties of the control surfaces in response to the control surface interface.

5. The aircraft control surface controller according to claim 1, further comprising an aerodynamic control surface responsive to the control surface interface.

6. The aircraft control surface controller according to claim 5, further comprising mechanical linkages interconnecting the control surface interface and the control surface.

7. The aircraft control surface controller according to claim 5, further comprising electromechanical devices interconnecting the control surface interface and the control surface.

8. The aircraft control surface controller according to claim 5, wherein the control surface is selected from the group consisting of an aileron, spoiler, rudder, flap, and elevator.

9. The aircraft control surface controller according to claim 1, wherein the variable resistance damper comprises an electromagnetic damper.

10. The aircraft control surface controller according to claim 9, wherein the electromagnetic damper comprises an eddy current drag device.

11. The aircraft control surface controller according to claim 9, wherein the electromagnetic damper comprises an electric motor.

12. The aircraft control surface controller according to claim 11, wherein the proportional resistance is established by electrically controlling a torque of the motor.

13. The aircraft control surface controller according to claim 11, wherein the electromagnetic damper further comprises a generator.

14. The aircraft control surface controller according to claim 1, wherein the variable resistance damper comprises a mechanical brake.

15. The aircraft control surface controller according to claim 14, wherein the mechanical brake comprises a centrifugal friction braking mechanism.

16. The aircraft control surface controller according to claim 1, further comprising a mechanical gear train interconnecting the control surface interface and the variable resistance damper.

17. The aircraft control surface controller according to claim 16, further comprising a clutch interconnecting the control surface interface and the variable resistance damper.

18. The aircraft control surface controller according to claim 16, further comprising a rivet assembly capable of being sheared at a predetermined force, the rivet interconnecting the control surface interface and the variable resistance damper.

19. The aircraft control surface controller according to claim 1, wherein the variable resistance damper is self contained.

20. An aircraft control surface controller, comprising:
a control surface interface having a range of motion for providing pilot input;
at least two aerodynamic control surfaces responsive to the control surface interface based on the pilot input; and
a variable resistance damper mechanically interconnected to the control surface interface, wherein the damper provides physical resistance to the control surface interface, the damper physical resistance increases proportional to a rate of movement of the control surface interface.

21. The aircraft control surface controller according to claim 20, further comprising a jam override device interconnecting one of the at least two control surfaces and the control surface interface, wherein the jam override device permits operation of one of the at least two control surfaces while the one control surface is in a jammed condition.

22. The aircraft control surface controller according to claim 21, wherein the jam override device has a preset detent force.

23. The aircraft control surface controller according to claim 20, wherein the variable resistance damper provides physical resistance to the control surface interface once the control surface interface exceeds an initial damping criterion corresponding to a predetermined rate of the control surface interface.

24. The aircraft control surface controller according to claim 23, wherein the variable resistance damper provides physical resistance to the control surface interface once the control surface interface exceeds a second initial damping criterion corresponding to a predetermined position of the control surface interface from a nominal position of the control surface interface.

25. The aircraft control surface controller according to claim 23, wherein the variable resistance damper initial damping criterion and physical resistance are selected based upon the physical response properties and aerodynamic effect properties of the control surfaces in response to the control surface interface.

26. The aircraft control surface controller according to claim 20, wherein the control surface is selected from the group consisting of an aileron, spoiler, rudder, and elevator.

27. The aircraft control surface controller according to claim 20, wherein the variable resistance damper comprises an electromagnetic damper.

28. The aircraft control surface controller according to claim 27, wherein the electromagnetic damper comprises an eddy current drag device.

29. The aircraft control surface controller according to claim 27, wherein the electromagnetic damper comprises an electric motor.

30. The aircraft control surface controller according to claim 29, wherein the proportional resistance is established by electrically controlling a torque of the motor.

31. The aircraft control surface controller according to claim 29, wherein the electromagnetic damper further comprises a generator.

32. The aircraft control surface controller according to claim 20, wherein the variable resistance damper comprises a mechanical brake.

33. The aircraft control surface controller according to claim 32, wherein the mechanical brake comprises a centrifugal friction braking mechanism.

34. The aircraft control surface controller according to claim 20, further comprising a mechanical gear train interconnecting the control surface interface and the variable resistance damper.

35. The aircraft control surface controller according to claim 34, further comprising a clutch interconnecting the control surface interface and the variable resistance damper.

36. The aircraft control surface controller according to claim 34, further comprising a rivet assembly capable of being sheared at a predetermined force, the rivet interconnecting the control surface interface and the variable resistance damper.

37. The aircraft control surface controller according to claim 20, further comprising mechanical linkages interconnecting the control surface interface and the control surface.

38. The aircraft control surface controller according to claim 20, further comprising electromechanical devices interconnecting the control surface interface and the control surface.

39. The aircraft control surface controller according to claim 20, wherein the variable resistance damper is self contained.

40. A method of controlling a control surface interface that controls an aerodynamic control surface on an aircraft, comprising:
receiving an input rate from the control surface interface; and
applying an increasing physical resistance to the control surface interface proportional to the input rate.

41. The method according to claim 40, wherein applying the physical resistance occurs once the control surface interface has moved beyond an initial damping criteria, wherein at least one initial damping criteria corresponds to a predetermined input rate of the control surface interface.

42. The method according to claim 41, wherein applying the physical resistance occurs beyond initial damping criteria, and at least one initial damping criteria corresponds to a predetermined position of the control surface interface from a nominal position of the control surface interface.

43. The method according to claim 41, wherein the step of applying the physical resistance includes initial damping criteria that are selected based upon the physical response properties and aerodynamic effect properties of at least one aerodynamic control surface in response to the control surface interface.
